(19) United States
(12) Patent Application Publication
(10) Pub. No.: US 2010/0233336 A1
(43) Pub. Date: Sep. 16, 2010

(54) Method for Producing a Protein-Containing Food Ingredient Consisting of a Flax Coarse Meal

(75) Inventors: Klaus Müller, Freising (DE); Peter Eisner, Freising (DE); Claudia Pickardt, Freising (DE); Michael Schott, Langenbach (DE); Heinz Kaiser, Berlin (DE)

Correspondence Address: MEREK, BLACKMON & VOORHEES, LLC, 673 S. WASHINGTON ST., ALEXANDRIA, VA, 22314, US

(73) Assignee: Fraunhofer-Gesellschaft zur Forderung der angewandten Forschung e.V., Munchen (DE)

(21) Appl. No.: 12/738,653

(22) PCT Filed: Oct. 21, 2008
(86) PCT No.: PCT/DE08/01715

§ 371 Date: Apr. 19, 2010

(30) Foreign Application Priority Data
Oct. 31, 2007 (DE) 10 2007 052 406.6
Aug. 21, 2008 (DE) 10 2008 039 103.4

(51) Int. Cl. A23L 1/28

(52) U.S. Cl. 426/430; 426/431

(57) ABSTRACT

The present invention relates to a method for producing a protein-containing food ingredient, in which flax coarse meal having a low residual oil content is produced or provided, from which parts of native flax protein and soluble roughage are dissolved or at least dispersed by aqueous extraction in an aqueous phase. The aqueous total extract thus obtained is freed of insoluble flax coarse meal fractions. Subsequently, a flax protein/roughage mixture is partitioned from the aqueous phase, in order to thus obtain the food ingredient. The food ingredient obtained in this way is taste-neutral, is technologically functional and storage-stable, and is distinguished by good protein solubility and outstanding boundary-surface properties.

### AREA OF APPLICATION

The invention relates to a method, using which a food ingredient is produced from flax coarse meal. The ingredient predominantly contains proteins and soluble roughage and is distinguished by taste neutrality, high solubility, boundary-surface-stabilizing properties in foams and emulsions, and by storage stability.

### PRIOR ART

Flax seeds are constructed from an outer shell, a germ, a thin endosperm, and two large cotyledons. The flattened cotyledons occupy 57% of the total mass of the seed, and the outer shell and the endosperm 38%. The germ of the flax seed forms the remaining 5%. 75% of the flax oil, and the majority of the proteins, are stored in the cotyledons. Seed shell and endosperm contain 22% of the total oil, only 3% is provided in the germ. The polysaccharides or also mucilage of the flax seeds are predominantly located in the outer areas of the shell. The seed of the oil flax plant contains up to approximately 45% oil, 25-35% protein, and 25-40% non-starch polysaccharides, of which approximately one-third is soluble roughage. All percentage components in the present patent application relate for this purpose to weight-percent.

Fully or partially crushed flax seeds are used in dough and as a sprinkling material on baked goods, as well as in muesli and health food products. The use of flax seeds in baked goods predominantly occurs because of their visual-sensorial properties, while in contrast in health food store products the physiological effect, which is primarily to be attributed to the mucilage fraction, is in the foreground. The majority of flax seeds are processed for industrial linseed oil production. The flax coarse meal which arises as a byproduct in linseed oil production has a high content of proteins and roughage and has primarily been used up to this point as animal feed or fertilizer, because chemically-related or enzymatically-related fat spoilage, which results in rancidity, occurs rapidly as a result of the high proportion of highly-unsaturated fatty acids in the residual oil component of the flax coarse meal (2-4%). The use of flax coarse meal in foods therefore has no industrial application.

The roughage in flax seeds can be divided into water-soluble non-starch polysaccharides (so-called mucilage or soluble roughage) and insoluble roughage such as lignin, cellulose, and hemicellulose. The soluble roughage makes up approximately one-third of the total roughage and has a neutral fraction (above all arabinoxylan) and an acid fraction, which primarily contains galacturonic acid, rhamnose, and galactose. Preparations made of soluble roughage have a residual protein content of 4-15% as a function of the extraction parameters and origin of the raw material.

Many of the positive physiological properties which are ascribed to flax seeds are to be attributed to the fraction of the soluble roughage. It increases the viscosity of the chyme in the small intestine and may thus flatten out the postprandial blood glucose level. The defecation-regulating effect of flax seed preparations is also connected to the soluble roughage.

The variations in the protein content of flax seeds are to be attributed to genetic factors and different growth conditions. The solubility of the nitrogen compounds occurring in flax seeds is a function, inter alia, of solvent, pH value, and temperature. Between 20% and 24% of the total nitrogen is soluble at the solubility minimum (pH 3.5-3.8), which is to be explained by the high content of acid-soluble albumin fractions. Flax seed proteins comprise 40.2% albumin and 40.0% globulin. The remainder is composed of glutelin (13.3%) and prolamin (6.5%). The ratio of essential acids to total amino acids is above the value of 36%, which was proposed by the WHO, in flax proteins.

Flax seed proteins may be isolated, purified, and concentrated using salt solutions and precipitation methods from flax seed meal using classical protein extraction methods, in order to obtain protein isolates. Protein isolates are distinguished by a high protein content of >90%. Procedures for alkaline extraction from partially-degreased flax meal in combination with acid precipitation and/or precipitation at the isoelectric point or alcohol precipitation of the protein and the soluble roughage in the extract, separation of the precipitate, and drying, are also known. Aqueous alcoholic solutions are typically used for the manufacture of protein concentrates, which have a lower protein content than isolates.

One advantage of protein isolates is the high purification and concentration of the protein component by one or more washing procedures. Protein isolates are typically sensorially acceptable and well suitable for food applications because of the high degree of purity and the high protein component (>90%). Typically, the lower the protein component, the more intensive the intrinsic taste of the products and therefore the less suitable the functional profile. Protein concentrates having protein contents of 60 to 80% normally have lesser solubility and significantly less pronounced boundary-surface properties (production and stabilization of foams and emulsions) than isolates.

Because of the high oxidation potential of residual fatty components, the isolates and concentrates may become rancid in a short time, however, and are then no longer suitable for use in foods. In addition, the functionality of proteins is strongly influenced by the pretreatment of the raw material, by precipitation processes, or by the treatment using alcohol. In particular, the solubilities and boundary-surface properties such as foaming capability or emulsion stabilization are reduced.

Good protein solubilities are provided if the solubility in the neutral range is greater than 60%. The foam activity, the foam density, and the foam stability are typically used as an index for outstanding foam properties. Whipping agents which are used in the food industry for producing foams have activities from 1000 to 2000% at density values of approximately 50 to 150 g/l. High activity and stability with low foam density are desirable. The disadvantage of commonly used whipping agents based on vegetable raw materials is the low stability of the foams. After 60 minutes of standing time, the initially produced foam volume has normally been reduced by more than 90%.

Emulsifying capacity and emulsion stability are used as an index for outstanding emulsifying properties. The emulsifying capacities of frequently used protein isolates are in the range from 300 to 600 ml oil/gram protein. In connection with the quantity of oil which can be stabilized by the protein in the emulsion (emulsifying capacity), the chronological stability of an emulsion having a defined composition is of decisive significance. For this purpose, one part protein is emulsified with 10 parts each water and oil (1:10:10) and it is checked what quantity of oil separates from the emulsion. High emulsifying capacities and high emulsion stabilities are desirable for the use of protein isolates in emulsion-based food systems.

Complexly produced protein isolates frequently do not fulfill the above-mentioned requirements in all points because of the specific required pretreatment of the raw materials and the procedure during the purification of the protein isolates.

Storage-stable products made of vegetable raw materials having outstanding sensorial properties in connection with outstanding solubilities and boundary-surface properties have not existed up to this point.

Following Table 1 shows exemplary properties of protein isolates produced by isoelectrical precipitation from soy, peas, and flax and the properties of typical whipping agents for producing food foams.

TABLE 1

| | Protein | Emulsifying | Emulsion | Foam | Foam | Foam |
|---|---|---|---|---|---|---|
| | solubility | capacity | stability | activity | density | stability |
| Sample | [%] | [g/ml] | [%] | [%] | [g/l] | [%] |
| Soy protein | 24 | 445 | 54 | — | — | — |
| isolate | | | | | | |
| Pea protein | 23 | 350 | n.a. | 490 | 193 | 84 |
| isolate | | | | | | |
| Flax | 48 | 535 | 97.5 | 910 | 120 | 100 |
| protein | | | | | | |
| isolate | | | | | | |
| Wheat | 100 | 375 | n.a. | 2100 | 41 | 8 |
| protein | | | | | | |
| hydrolysate | | | | | | |
| (whipping | | | | | | |
| agent) | | | | | | |
| Chicken egg | 100 | 800 | 52 | 1800 | 53 | 80 |
| albumen | | | | | | |
| (whipping | | | | | | |
| agent) | | | | | | |

The object of the present invention comprises producing a taste-neutral, technologically functional, and storage-stable protein-containing food ingredient from flax coarse meal. The ingredient is to be distinguished by good protein solubility and outstanding boundary-surface properties, in order to be able to produce and stabilize food foams and emulsions. In addition, the dried ingredient is to be storage-stable, i.e., no sensorial changes are to occur during storage, which would no longer allow use in foods.

### DESCRIPTION OF THE INVENTION

The object is achieved by the method according to claim 1. Advantageous embodiments of the method are the subject matter of the dependent claims or may be inferred from the following description.

In the proposed method, firstly, flax coarse meal having a residual oil content of 1% is produced or provided. For this purpose, for example, flax coarse meal arising during industrial linseed oil production, which frequently has residual oil contents between 3 and 4%, can be further deoiled suitably. Furthermore, cold-pressed linseed press cakes can also be used as a starting material, from which the flax coarse meal is obtained by deoiling to the required residual oil content. Alternatively, flax coarse meal having a residual oil content of 5% can also be produced or provided, if it is subsequently ground with exclusion of air oxygen. Parts of native flax protein and soluble roughage which are contained in the flax coarse meal are then dissolved or at least dispersed from the flax coarse meal by aqueous extraction in an aqueous phase. The aqueous total extract thus obtained is freed of insoluble flax coarse meal fractions, such as insoluble fibers. A flax protein roughage mixture is partitioned from the aqueous phase, whereby the food ingredient is obtained without further purification. The partitioning is preferably performed by a drying step, it being advantageous to concentrate the flax protein roughage mixture before the drying by filtration and/or evaporation in order to achieve more efficient drying.

Surprisingly, the dried total extract which has been freed of insoluble components, in particular fibers, displays outstandingly good taste and boundary-surface-active properties even without further purification and concentration of the protein component, as have otherwise only been found in highly concentrated and purified protein isolates. In addition, this food ingredient has a high solubility of the protein component and long shelf life, without sensorial spoilage occurring through oxidation.

The use of cold-pressed linseed press cakes in combination with careful residual deoiling of the press cake to 1% residual fat or less in connection with subsequent cold grinding of the flax coarse meal with exclusion of air oxygen is particularly advantageous. This combination allows a purely aqueous extraction of native flax protein and soluble flax roughage having outstanding taste and functional properties and longer storage stability. Careful deoiling is achieved in that the required desolventizing of the solvent used during the oil separation is performed at temperatures at which the proteins are not damaged. The cold grinding is preferably performed in this case and also in the case of flax coarse meal having a residual oil content of 5% to a particle size of 200 to 1000 μm with an average particle size of d50=400 μm.

The further deoiling of the cold-pressed linseed press cake or the flax coarse meal using hexane to residual oil contents of less than 1% in connection with the desolventizing of the further deoiled flax coarse meal at temperatures less than 60° C. has proven to be particularly advantageous to obtain the native properties of the flax protein during the manufacture of the food ingredient.

Through the careful processing of the cold-pressed linseed press cake or flax coarse meal, a higher proportion of the native flax protein can be dispersed and dissolved in water together with soluble roughage and partitioned from insoluble flax fibers as a total extract. It is particularly advantageous for the production of large quantities of native flax protein if a pH value of pH=6 to pH=9 is set in the extraction medium during the extraction. In particular, a significant improvement of the taste properties and the storage stability of the fiber-free total extract is displayed upon setting of pH values below pH=7, the total extract being concentrated and dried using careful method steps, for example, by ultrafiltration and/or vacuum vaporization and subsequent spray drying.

The dried powder is a food ingredient having less than 60% native flax protein and greater than 30% soluble roughage. The solubility of the protein in the food ingredient thus produced is greater than 60% and thus differs astoundingly significantly positively from the protein isolates obtained by isoelectric precipitation (see Table 1). In addition, the combination of native flax protein of higher solubility and soluble flax roughage in the novel food ingredient surprisingly results, even with a protein component of less than 60%, in a foam activity of greater than 1100% at a foam density of 94 g/l and a foam stability of 100%, which in turn differs significantly positively from the foam properties of the protein isolates produced by isoelectric precipitation. The novel food ingredient also has astoundingly high values of 98% with respect to the emulsion stability, in spite of the lower protein component, as well as emulsifying capacities which are in the range of protein isolates (350 ml/g).

Because of the good taste properties, the outstanding functionality with respect to solubility, foam properties, and emulsifying properties, and because of the long stability in relation to oxidative spoilage and thus long shelf life, the novel food ingredient is suitable as a food ingredient usable in surprisingly manifold ways for improving quality features of foods, which can otherwise only be achieved by the use of protein isolates. This relates above all to sensorial properties (taste, odor, color), texture properties (viscosity, structure, gel formation, stability of emulsions and foams), and the lengthening of shelf life. The enrichment and stabilization of beverages, the improvement of structure and texture of baked goods and puff pastry, and the formation and stabilization of foams and emulsions in the field of sweets and desserts or delicatessen products are to be particularly emphasized for this purpose.

### Exemplary Embodiment

Industrially manufactured linseed press cakes are set to residual oil contents of less than 1% by extraction using industrial hexane.

The percolator of the extraction facility is filled with 100 kg of the linseed press cake for this purpose and subsequently extracted in multiple passages. In the first passage, extraction is performed using 200 l of hexane and in the further passages, extraction is performed using 150 l of hexane in each case at an average of 45° C. for 4 hours. The percolation is performed from top to bottom, the fill level of the percolator being set so that the press cake is completely covered with hexane. As soon as less than 1% residual fat is achieved in the coarse meal, the extraction is followed by the removal of the extracting agent by stripping the linseed expeller using supercritical hexane vapor. For this purpose, stripping is performed for 4 hours using a total of 550 kg hexane vapor in a vacuum of −0.6 bar until a vapor temperature of 40° C. is achieved. This is followed by one hour of stripping using ingredient vapor at 60° C. and a vacuum of −0.75 bar.

The desolventized linseed extraction coarse meal is ground to a particle size less than 400 μm using a refrigerated mill under nitrogen atmosphere and used for producing the food ingredient according to the invention. One part flax coarse meal is admixed and suspended with 12 parts water at 50° C. for this purpose. The pH value of the batch is set to 8 using 3 m sodium hydroxide and stirred intensively. After minutes, insoluble fibers are partitioned from the protein-containing extract using decanters (throughput 1000 l/hour) at a speed of 4400 RPM and a counter pressure of 3.5 bar. The extract is set using 3 m hydrochloric acid to a pH value of 6.8 and evaporated to a concentration of approximately 20% dry mass in a falling-film evaporator at a maximum of 75° C. and a vacuum of −0.6 bar and subsequently dried in the spray dryer at 180° C. air intake temperature. The dried powder represents the food ingredient according to the invention.

1. A method for producing a protein-containing food additive, wherein
either flax coarse meal having a residual oil content of ≦1% is produced or provided,
or flax coarse meal having a residual oil content of ≦5% is produced or provided and subsequently ground under exclusion of air oxygen,
parts of native flax protein and soluble roughage which are contained in the flax coarse meal are dissolved or at least dispersed by aqueous extraction in an aqueous phase, whereby an aqueous total extract is obtained,
the aqueous total extract is freed of insoluble flax coarse meal fractions, and
a flax protein/roughage mixture is partitioned from the aqueous phase, in order to thus obtain the food ingredient.

2. The method according to claim 1,
wherein the flax protein/roughage mixture is concentrated by filtration and/or evaporation and subsequently dried for the partition from the aqueous phase.

3. The method according to claim 1,
wherein the flax coarse meal having a residual oil content of ≦1% is obtained by deoiling flax coarse meal having a higher residual oil content.

4. The method according to claim 1,
wherein the flax coarse meal having a residual oil content of ≦1% is obtained by deoiling cold-pressed linseed press cakes.

5. The method according to claim 3,
wherein a desolventizing of the flax coarse meal from the solvent used during the deoiling is performed at temperatures less than 60° C.

6. The method according to claim 5,
wherein the deoiling is performed using hexane as the solvent.

7. The method according to claim 1,
wherein the flax coarse meal is pulverized before the aqueous extraction by cold grinding with exclusion of air oxygen.

8. The method according to claim 7,
wherein the cold grinding is performed to a particle size of 200 to 1000 μm with an average particle size of d50=400 μm.

9. The method according to claim 1,
wherein a pH value of pH=6 to pH=9 is set in the extraction medium during the aqueous extraction.

10. The method according to claim 9,
wherein a pH value of less than pH=7 is set in the extraction medium during the aqueous extraction.

11. The method according to claim 1,
wherein the flax protein/roughage mixture is concentrated and dried to obtain a dried powder, said dried powder having less than 60% native flax protein and greater than 30% soluble roughage.

12. The method according to claim 11,
wherein the dried powder has a solubility a foam activity of greater than 1100%.

13. The method according to claim 4,
wherein a desolventizing of the flax coarse meal from the solvent used during the deoiling is performed at temperatures less than 60° C.
